(19) United States
(12) Patent Application Publication
(10) Pub. No.: US 2025/0067147 A1
(43) Pub. Date: Feb. 27, 2025

(54) WELLBORE CLEAN-UP SCENARIO-BASED OPTIMIZATION

(71) Applicant: Schlumberger Technology Corporation, Sugar Land, TX (US)

(72) Inventors: Bertrand Claude Emile Theuveny, Paris (FR); William J. Bailey, Somerville, MA (US); Kashif Rashid, Wayland, MA (US); Glen Andrew Hay, Calgary (CA)

(21) Appl. No.: 18/453,668

(22) Filed: Aug. 22, 2023

(51) Int. Cl. E21B 37/00; E21B 47/26

(52) U.S. Cl. CPC E21B 37/00; E21B 47/26; E21B 2200/20

(57) ABSTRACT

Systems and methods of the present disclosure provide systems and methods for receiving an indication of criteria for a function to be performed at a commercial process facility. The criteria are used to determine one or more scenarios that meet the criteria. Coupled simulators then generate one or more route maps from the one or more scenarios. A route map is selected from the one or more route maps that causes at least one operation of the route map to be performed.

### FIELD OF THE INVENTION

This disclosure relates generally to hydrocarbon production and exploration and, more particularly, to methods and apparatuses to monitor wellbore clean-up operations.

### BACKGROUND INFORMATION

Wellbores may be drilled into subsurface rocks to create wells to access subterranean fluids, such as hydrocarbons, stored in subterranean formations. When these subterranean fluids are produced from the wells, it may be desirable to obtain certain characteristics of the produced fluids to facilitate efficient and economic exploration and production. For example, it may be desirable to obtain flow rates and/or other characteristics of the produced fluids. These produced fluids are often multiphase fluids (e.g., having some combination of water, oil, and gas).

Well clean-up is an initial phase of a well test and begins with opening the well. During this phase, non-reservoir fluids, such as completion, drilling, and stimulation fluids, are produced to the surface together with reservoir fluids. At this stage, the effluent composition may be at least partially unknown, and the flow can be unstable and characterized by a slug flow. The clean-up phase may vary from scenario to scenario and facility to facility and for different objective functions. Thus, a single clean-up flow plan may not be suitable for all scenarios, facilities, and objective functions.

### SUMMARY

A summary of certain embodiments described herein is set forth below. It should be understood that these aspects are presented merely to provide the reader with a brief summary of these certain embodiments and that these aspects are not intended to limit the scope of this disclosure.

In one embodiment, a method includes receiving an indication of criteria for a function to be performed at a commercial process facility. The criteria are used to determine one or more scenarios that meet the criteria. Coupled simulators then generate one or more route maps from the one or more scenarios. A route map is selected from the one or more route maps that causes at least one operation of the route map to be performed.

In another embodiment, a system includes one or more memory devices storing instructions and one or more processors configured to execute the instructions to cause the one or more processor to transmit control variables for a wellbore clean-up operation of a wellbore to a wellbore clean-up simulator. The instructions also cause the one or more processors to run the wellbore clean-up simulator using the control variables and run a commercial process facility simulator in a coupled configuration with the wellbore clean-up simulator based at least in part on the control variables. The commercial process facility simulator simulates the clean-up operation in a commercial process facility that comprises the wellbore. Moreover, the instructions cause the one or more processors to output a function based on both simulators in the coupled configuration.

In a further embodiment, a system includes one or more memory devices storing instructions and one or more processors configured to execute the instructions to cause the one or more processors to receive an indication of criteria for a function to be performed at a commercial process facility. The instructions also cause the one or more processors to transmit control variables for one or more facility scenarios to a wellbore clean-up operation of a wellbore to a wellbore clean-up simulator. Additionally, the instructions cause the one or more processors to run the wellbore clean-up simulator using the control variables and to run a commercial process facility simulator in a coupled configuration with the wellbore clean-up simulator based at least in part on the control variables. The commercial process facility simulator simulates the clean-up operation for the one or more scenarios in a commercial process facility that comprises the wellbore. The instructions also cause the one or more processors to output a respective result for each of the one or more scenarios based on both simulators in the coupled configuration and to select a result from the respective results. Furthermore, the instructions cause the one or more processors to cause at least one action to be performed at the wellbore based on the selected result.

### BRIEF DESCRIPTION OF THE DRAWINGS

Various aspects of this disclosure may be better understood upon reading the following detailed description and upon reference to the drawings, in which:

FIG. 1 illustrates a diagram of a data capturing system used to capture data in and/or around an oilfield, such as in a wellbore, in accordance with embodiments of the present disclosure;

FIG. 2 illustrates a computing system used to process data from the data capturing system of FIG. 1, in accordance with embodiments of the present disclosure;

FIG. 3 illustrates a process for performing a deterministic optimization for a clean-up operation of the wellbore, in accordance with embodiments of the present disclosure;

FIG. 4 illustrates a process for performing an optimization for a clean-up operation of the wellbore with at least one uncertainty, in accordance with embodiments of the present disclosure;

FIG. 5 illustrates a process for computing a function for the processes of FIGS. 3 and 4 using a coupled configuration for two (or more) emulators, in accordance with embodiments of the present disclosure;

FIG. 6 illustrates a multiple scenario computation using the coupled configuration for two (or more) emulators, in accordance with embodiments of the present disclosure; and

FIG. 7 illustrates a process for utilizing optimization in a commercial process facility with the coupled configuration for two (or more) emulators, in accordance with embodiments of the present disclosure.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments. Furthermore, “optimize” as used herein is intended to cover scenarios where certain objectives/parameters are enhanced or improved even if there may be further improvement available. In other words, an operation may be optimized without being the most optimized possible solution.

During the clean-up period of a well test, various operations may be implemented. For instance, pre-job wellhead surface equipment optimization may be implemented for a wellbore clean-up to maximize some objective function, F. For instance, F may non-exclusively include a function to maximize clean-up quality in a least amount of time, minimize CO₂ emissions, minimize an amount of area occupied by wellhead equipment and connections, minimize sound emission, and/or other suitable functions that may be used. To successfully optimize based on F, two or more simulators may be coupled and/or integrated: a wellbore clean-up simulator and a commercial process facility simulator. As discussed below, this coupling may be implemented using cloud computing/distributed computing. Furthermore, as F may be different for different scenarios, the discussion herein may be applicable to distinct facility scenarios with different objectives by using coupled emulators to compute F dynamically based on facility configurations and scenarios. Moreover, since the wellbore clean-up job may be optimized for different discrete facility scenarios, the optimization may be performed in a deterministic or non-deterministic manner depending on whether there are uncertainties (e.g., well-depth, etc.) related to the facility (e.g., wellbore).

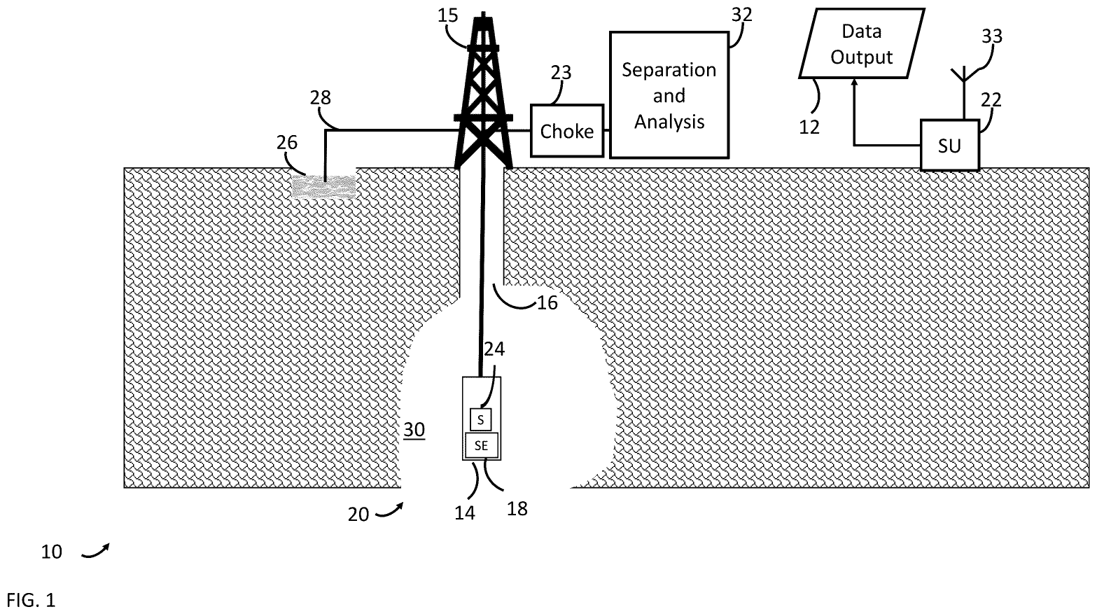

With the foregoing in mind, FIG. 1 illustrates a data capturing system 10 to capture and produce data output 12 in an oilfield that is captured as part of a clean-up operation, wireline operation, pumping operation, drilling operation, extraction operation, or any other operation being performed. In the illustrated embodiment, the data capture is being at least partially performed by a wireline tool 14 suspended by a rig 15 and into a wellbore 16 during drilling. During production/clean-out data may be acquired using other tools (e.g., surface measurements). The wireline tool 14 is adapted for deployment into wellbore 16 for generating well logs, performing downhole tests, collecting samples, and/or collecting any other data. For instance, the wireline tool 14 may assist in performing a logging while drilling (LWD) operation. Additionally or alternatively, the wireline tool 14 may, for example, have an explosive, radioactive, electrical, or acoustic energy source 18 that sends and/or receives electrical signals to surrounding subterranean formations 20 and/or fluids therein. Return signals may be detected using the wireline tool 14 and/or other tools located at other locations at/near the oilfield.

Computer facilities may be positioned at various locations about the oilfield (e.g., the surface unit 22) and/or at remote locations. The surface unit 22 may be used to communicate with the wireline tool 14 and/or offsite operations, as well as with other surface or downhole sensors. The surface unit 22 is capable of communicating with the wireline tool 14, pumps, a choke 23, and/or other equipment. For instance, the choke 23 may be an adjustable choke that controls fluid flow out of the wellbore. The surface unit 22 may also collect data generated during the drilling operation, clean-out operation, production operation, and/or logging and produces data output 12, which may then be stored or transmitted. In other words, the surface unit 22 may collect data generated during the clean-out operation and may produce data output 12 that may be stored or transmitted.

The surface unit 22 may include one or more various sensors and/or gauges that may additionally or alternatively be located at other locations in the oilfield. These sensors and/or gauges may be positioned about the oilfield (e.g., in/at the rig 15) to collect data relating to various field operations. As shown, at least one downhole sensor 24 is positioned in the wireline tool 14 to measure downhole parameters which relate to, for example porosity, permeability, fluid composition and/or other parameters of the field operation. During drilling, different or more parameters, such as weight on bit, torque on bit, pressures, temperatures, flow rates, compositions, rotary speed, and/or other parameters of the field operation, may be measured.

The surface unit 22 may include a transceiver 33 to enable communications between the surface unit 22 and various portions of the oilfield or other locations. The surface unit 22 may also be provided with or functionally connected to one or more controllers for actuating mechanisms at the oilfield. The surface unit 22 may then send command signals to the oilfield in response to data received. The surface unit 22 may receive commands via the transceiver 33 or may itself execute commands to the controller. A computing system including a processor may be included to analyze the data (locally or remotely), make decisions, control operations, and/or actuate the controller. In this manner, the oilfield may be selectively adjusted based on the data collected. This technique may be used to enhance portions of the field operation, such as controlling drilling, weight on bit, pump rates, and/or other parameters. These adjustments may be made automatically based on an executing application with or without user input.

A mud pit 26 is used to draw drilling mud into the drilling tools via flow line 28 for circulating drilling mud down through the drilling tools, then up wellbore 16 and back to the surface. The drilling mud may be filtered and returned to the mud pit 26. A circulating system may be used for storing, controlling, or filtering the flowing drilling muds. The drilling tools are advanced into subterranean formations 20 to reach a reservoir 30. Each well may target one or more reservoirs.

Generally, the wellbore 16 is drilled according to a drilling plan that is established prior to drilling. The drilling plan sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also be adjusted as new information is collected.

After the drilling operation is completed, at least some drilling mud and/or other materials other than the desired subterranean fluid may remain in the wellbore. To remove these unwanted materials, a clean-up operation may be performed. As effluent travel upwards through the wellbore 16, it travels through the choke 23. As previously noted, this effluent may be multiphase consisting of multiple fluids (e.g., oil, gas, and water). This multiphase fluid traverses the choke 23 and enters into a separation and analysis system 32. The separation and analysis system 32 may be at least partially included in the surface unit 22. The separation and analysis system 32 may include a horizontal separator, a vertical separator, and/or any other mechanisms that may facilitate separation of the incoming effluent. For instance, the separator may include a 3-phase gravity separator that separates the effluent into its separate gas, oil, and water sub-elements. The analysis portion of the separation and analysis system 32 may test for how successful the separation of the sub-elements has been. Additionally or alternatively, the analysis portion of the separation and analysis system 32 may determine flow rates of water and other liquids to determine whether the clean-up has been completed. Additionally, if the effluent contains solids, analysis portion of the separation and analysis system 32 may determine the value of basic sediments and water (BSW) in the effluent to determine whether the clean-up operation has been completed.

The data gathered by sensors 24 may be collected by the surface unit 22 and/or other data collection sources for analysis or other processing. The data collected by the sensors 24 may be used alone or in combination with other data. The data may be collected in one or more databases and/or transmitted to another location on-site or off-site. The data may be historical data, real time data, or combinations thereof. The real time data may be used in real time, or stored for later use. The data may also be combined with historical data and/or other inputs for further analysis. The data may be stored in separate databases and/or combined into a single database.

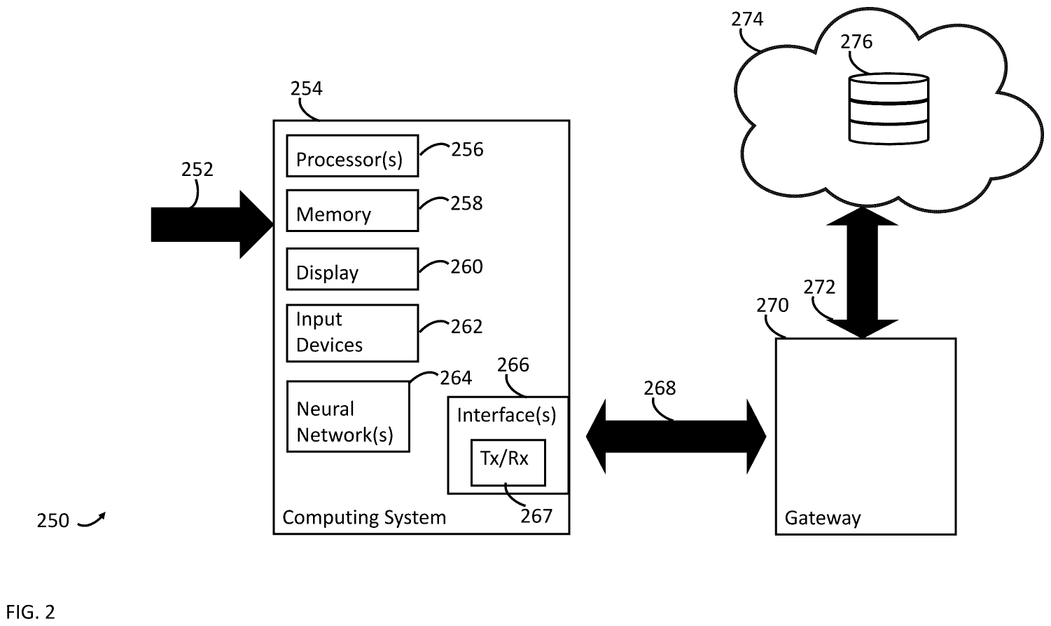

FIG. 2 is a block diagram of a system 250 that may be used for analyzing/utilizing the data output 12 from the data capturing system 10, as described in FIG. 1. The data output 12, as described in FIG. 1, is received as input data 252 at a computing device 254. The computing device 254 may be implemented in the surface unit 22 and/or may be implemented at other locations within the oilfield or remotely from the oilfield where the remote locations are able to receive the data via the transceiver 33. The various functional blocks shown in FIG. 2 may include hardware elements (including circuitry), software elements (including computer code stored on a tangible computer-readable medium), or a combination of both hardware and software elements. It should be noted that FIG. 2 is merely one example of a particular implementation and is intended to illustrate the types of components that may be present in the computing device 254.

As illustrated, the computing device 254 includes one or more processor(s) 256, a memory 258, a display 260, input devices 262, one or more neural networks(s) 264, and one or more interface(s) 266. In the computing device 254, the processor(s) 256 may be operably coupled with the memory 258 to facilitate the use of the processors(s) 256 to implement various stored programs. Such programs or instructions executed by the processor(s) 256 may be stored in any suitable article of manufacture that includes one or more tangible, computer-readable media at least collectively storing the instructions or routines, such as the memory 258. The memory 258 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor(s) 256 to enable the computing device 254 to provide various functionalities.

The input devices 262 of the computing device 254 may enable a user to interact with the computing device 254 (e.g., pressing a button to increase or decrease a volume level). The interface(s) 266 may enable the computing device 254 to interface with various other electronic devices. The interface(s) 266 may include, for example, one or more network interfaces for a personal area network (PAN), such as a Bluetooth network, for a local area network (LAN) or wireless local area network (WLAN), such as an IEEE 802.11x Wi-Fi network or an IEEE 802.15.4 wireless network, and/or for a wide area network (WAN), such as a cellular network. The interface(s) 266 may additionally or alternatively include one or more interfaces for, for example, broadband fixed wireless access networks (WiMAX), mobile broadband Wireless networks (mobile WiMAX), and so forth.

In certain embodiments, to enable the computing device 254 to communicate over the aforementioned wireless networks (e.g., Wi-Fi, WiMAX, mobile WiMAX, 4G, LTE, and so forth), the computing device 254 may include a transceiver (Tx/Rx) 267. The transceiver 267 may include any circuitry that may be useful in both wirelessly receiving and wirelessly transmitting signals (e.g., data signals). The transceiver 267 may include a transmitter and a receiver combined into a single unit.

The input devices 262, in combination with the display 260, may allow a user to control the computing device 254. For example, the input devices 262 may be used to control/initiate operation of the neural network(s) 264. Some input devices 262 may include a keyboard and/or mouse, a microphone that may obtain a user's voice for various voice-related features, and/or a speaker that may enable audio playback. The input devices 262 may also include a headphone input that may provide a connection to external speakers and/or headphones.

The neural network(s) 264 may include hardware and/or software logic that may be arranged in one or more network layers. In some embodiments, the neural network(s) 264 may be used to implement machine learning and may include one or more suitable neural network types. For instance, the neural network(s) 264 may include a perceptron, a feed-forward neural network, a multi-layer perceptron, a convolutional neural network, a long short-term memory (LSTM) network, a sequence-to-sequence model, and/or a modular neural network. In some embodiments, the neural network(s) 264 may include at least one deep learning neural network.

The output of the neural network(s) 264 may be based on the input data 252, such as flow rates or other data captured during drilling, clean-out, and/or other operations. This output may be used by the computing device 254. Additionally or alternatively, the output from the neural network(s) 264 may be transmitted using a communication path 268 from the computing device 254 to a gateway 270. The communication path 268 may use any of the communication techniques previously discussed as available via the interface(s) 266. For instance, the interface(s) 266 may connect to the gateway 270 using wired (e.g., Ethernet) or wireless (e.g., IEEE 802.11) connections. The gateway 270 couples the computing device 254 to a wide-area network (WAN) connection 272, such as the Internet. The WAN connection 272 may couple the computing device 254 to a cloud network 274. The cloud network 274 may include one or more computing devices 254 grouped into one or more locations (e.g., data centers). The cloud network 274 includes one or more databases 276 that may be used to store the output of the neural network(s) 264. In some embodiments, the cloud network 274 may perform additional transformations on the data using its own processor(s) 256 and/or neural network(s) 264.

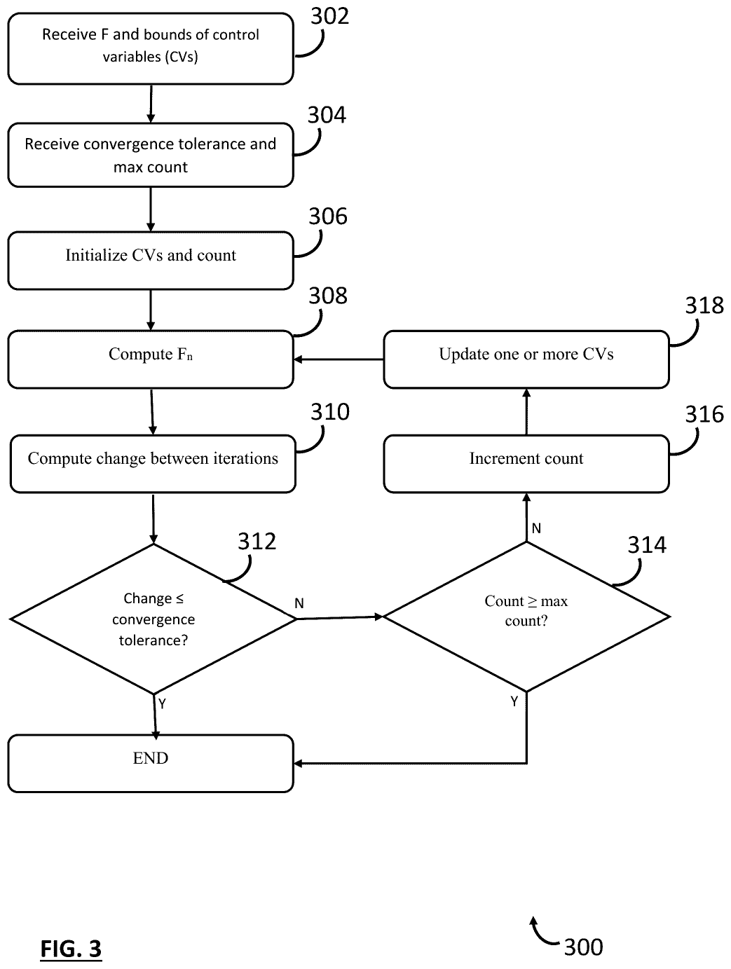

The computing device 254 may be used to perform an optimization process to optimize for the objective function, F. For instance, FIG. 3 is a block diagram of a process 300 for performing a deterministic optimization that may be performed using the computing device 254. As illustrated, the computing device 254 receives F and bounds of control variables (CVs) (block 302). For instance, F may be received as defined by a user via the input devices 262, pulled from the memory 258, received as a selection from presented possible functions, and/or other mechanisms suitable for defining the objective function, F. Similarly, the bounds for the CVs may be defined and/or received by the computing device 254. Furthermore, the computing device 254 receives a convergence tolerance and max count (block 304). The convergence tolerance and/or the max count may be defined similarly to how the CVs and/or F is received. The convergence tolerance and/or the max count control how many iterations are to be performed. A larger convergence tolerance deems the optimization converged or optimized at an earlier time while the max count defines a maximum number of iterations before the optimization using the process 300 is halted. In other words, a higher threshold condition will be met earlier than a lower one.

The computing device 254 initializes the CVs and a count (block 306). For instance, the count may set an index (e.g., n) for values (e.g., x) to a first value (e.g., Xₙ₌₁). Using these CV values, the computing device 254 computes a corresponding F for the count (e.g., Fₙ) (block 308). As is described below in further detail, the computation of the corresponding F using the CV values may be calculated using coupled emulators that perform a “trial” using the CVs in tandem. The computing device 254 may determine a maximum change from a maximum of the previous iteration (e.g., initially set to some default value, such as undefined) (block 310). For instance, the computing device 254 may determine a maximum change of the corresponding F and a previously computed F (or undefined value).

The computing device 254 may then determine whether the change is less than or equal to the convergence tolerance (block 312). For instance, the computing device 254 may subtract the corresponding function from the max of the previous iteration. If the absolute value of the difference is less than or equal to the convergence tolerance, the corresponding function may be deemed “optimized,” and the process 300 may end.

If the difference is less than the convergence tolerance, the computing device 254 may determine whether the maximum count, as previously defined, has been reached (block 314). If the max count has been reached, the computing device 254 may end the process 300. If the count is less than the maximum count, the computing device 254 increments the count (block 316). The computing device 254 then updates the CVs (e.g., xₙ) based on the incremented count (block 318). With the updated CVs, the computing device 254 may re-compute the new corresponding function F, and the process 300 starts over from block 308.

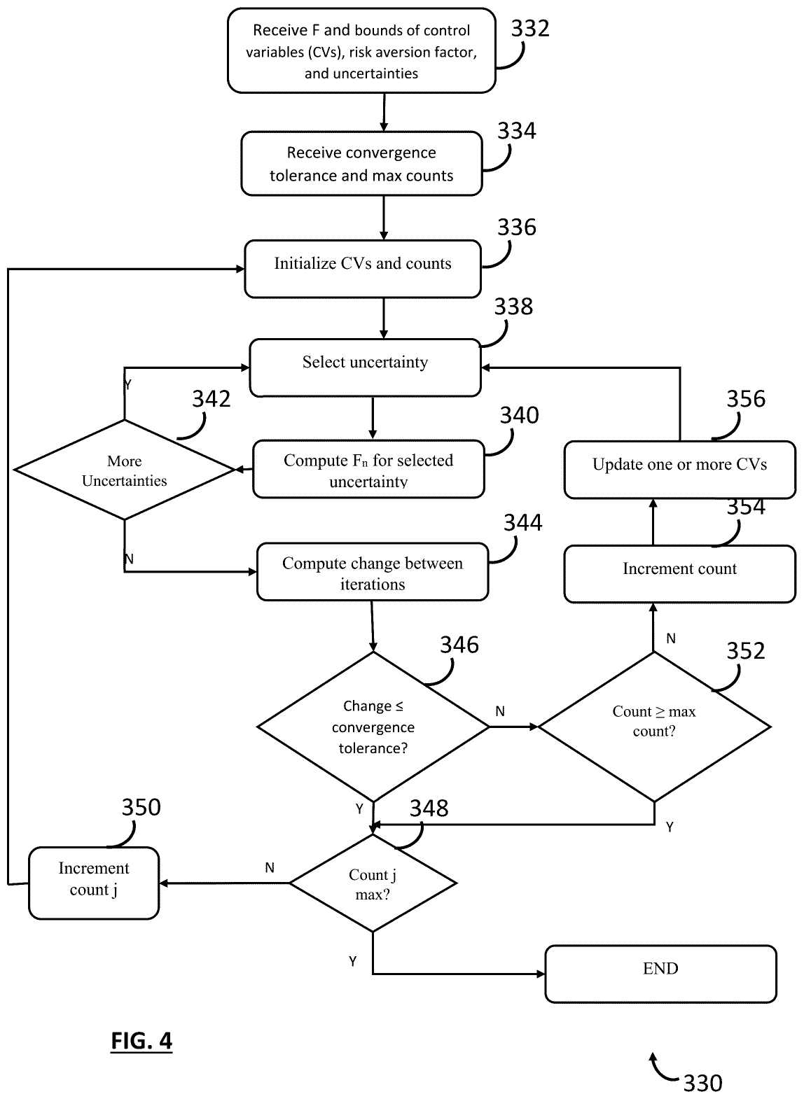

FIG. 4 is a flow chart of a process 330 that is an optimization with one or more uncertainties using the computing device 254. Such uncertainty may be related to static reservoir 30 properties, depth and severity of fluid invasion in the near wellbore region, and/or layer-specific productivity indexes. As illustrated, the computing device 254 receives F, bounds of control variables (CVs), a risk aversion factor, and one or more uncertainties (e.g., U₁, U₂, . . . . U_{K}) (block 332). Furthermore, the computing device 254 receives a convergence tolerance and max counts (block 334). The function F, bounds of CVs, the risk aversion, the one or more uncertainties, the convergence tolerance, and/or the max count may be received/determined in any of the methods discussed above in relation to the function F, the bounds of the CV, the convergence tolerance, or the max count in relation to FIG. 3. Specifically, in some embodiments, the risk aversion may be a user-defined risk aversion used to indicate how much risk to take during in the optimization. As previously described, the convergence tolerance and/or the max count control how many iterations are to be performed. As previously noted, a larger convergence tolerance deems the optimization converged or optimized at an earlier time while the max count defines a maximum number of iterations before the optimization using the process 330 is halted. The block 334 may be similar to the block 302 except that there are additional counts. A count (e.g., count j) may be used to index risk aversion factors to enable computing F for different risk aversion factors. Another count (e.g., count k) may be used to index uncertainties to enable computing F for multiple uncertainties. Each of the counts may be used with their own max counts.

The computing device 254 initializes the CVs and counts (block 336) similar to block 306. The computing device 254 selects one uncertain value (Uₖ) from the uncertainties using the count (block 338). Using these CV values, the risk aversion factor, and the selected uncertainty, the computing device 254 computes a corresponding F for the count (e.g., Fₙ) (block 340). As previously noted and as is described below in further detail below, the computation of the corresponding F using the CV values, risk aversion factor, and selected uncertainty may be calculated using coupled emulators that perform a “trial” using the CVs in tandem. The computing device 254 then determines whether there are more uncertainties to be used for the set of CVs (block 342). If more uncertainties are to be used, the computing device 254 selects another uncertainty (e.g., U₁) and computes an alternative corresponding function.

Using the CV values and corresponding uncertainties, the computing device 254 may determine a maximum change from a maximum of the previous iterations (e.g., initially set to some default value, such as undefined) (block 344). Furthermore, this computation may be based on the risk aversion factor with F(xₙ|λⱼ, U)=μ(xₙ|U)−μⱼσ (xₙ|U), wherein xₙ are the CVs, λⱼ is the risk aversion factor indexed with count j. F=μ−λσ is a generic optimization under uncertainty algorithm where μ is the mean and σ is a standard deviation.

The computing device 254 may then determine whether the change is less than or equal to the convergence tolerance (block 346). For instance, the computing device 254 may subtract the corresponding function from the max of the previous iteration. If the absolute value of the difference is less than or equal to the convergence tolerance, the corresponding function may be deemed “optimized.” Once the convergence tolerance is reached, the computing device 254 determines whether the current count j is greater than a count j max (block 348). If the count j has reached its max, the process 330 ends. If the count j has not reached its max, computing device 254 increments count j (block 350). If the count j has reached its maximum number, the process 330 ends. If the count j has not reached its max, computing device 254 increments count j (block 350) and proceeds to repeat computations for a different risk aversion factor. In some embodiments, the CVs and/or at least some of the counts may be initialized to a starting point for the new computations.

If the difference is less than the convergence tolerance or the count j has been incremented, the computing device 254 determines whether the maximum count, as previously defined, has been reached (block 352). If the max count has been reached, the computing device 254 may proceed the process 330 to block 348 to check whether the count j max has been reached. If the count is less than the maximum count, the computing device 254 increments the count (block 354). The computing device 254 then updates the CVs (e.g., xₙ) based on the incremented count (block 356). With the updated CVs, the computing device 254 may re-compute the new corresponding function F, and the process 330 starts over from block 338.

As previously discussed, to ensure correct simulator response for each facility scenario and the associated wellbore clean-up, two or more simulators may be used. Two simulators, a wellbore clean-up simulator and a commercial process facility simulator, are to be coupled together in a single optimization “trial.” In this trial, previously defined CVs are fed into both wellbore clean-up simulator and (if necessary) commercial process facility simulator to furnish a user-specified objective function, F, in tandem.

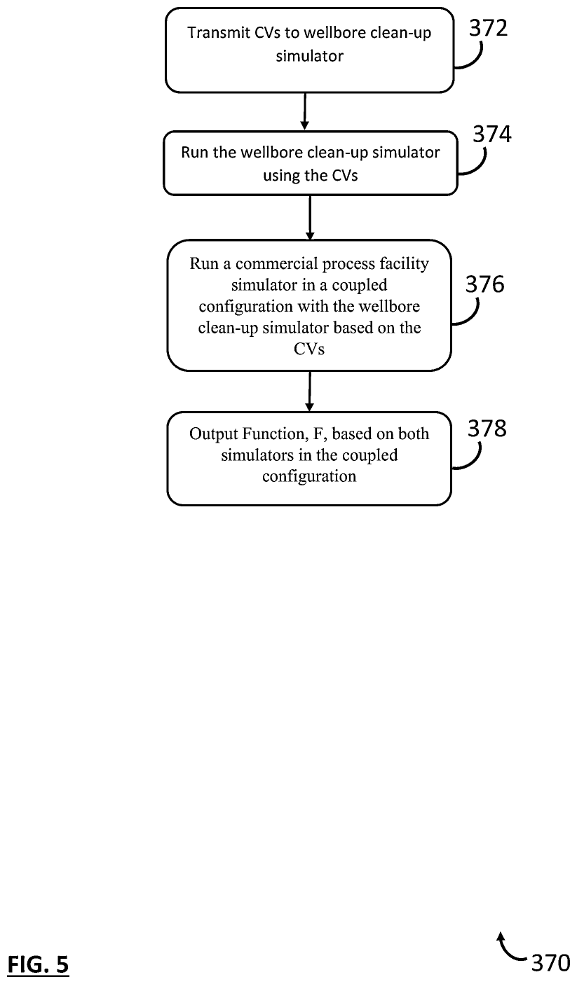

Accordingly, FIG. 5 shows a flow chart of an embodiment of a process 370 that may be implemented in the blocks 308 and/or 340. As illustrated, the computing device 254 passes the CVs to a wellbore clean-up simulator (block 372). The computing device 254 may implement the wellbore clean-up simulator or may be coupled to another computing device/cloud that implements the wellbore clean-up simulator as instructions stored in memory and executed by a processor. The computing device 254 causes the wellbore clean-up simulator to be run using the CVs (block 374). The computing device 254 runs or causes the commercial process facility simulator to be run in a coupled configuration with the wellbore clean-up simulator (block 376). The commercial process facility simulator may be implemented as instructions stored in memory and executed by a processor. Furthermore, the commercial process facility simulator may be implemented on a same computing device as the wellbore clean-up simulator or may be implemented on a separate computing device. A coupled configuration, as used herein, indicates that the commercial process facility simulator and the wellbore clean-up simulator are communicatively coupled to share the same CVs, share outputs with each other, or otherwise depend on each other for at least some data in a single, combined trial of an optimization. For instance, the wellbore clean-up simulator may use the CVs in simulation, and the commercial process facility simulator may be used to simulate and control operations in the oilfield or other commercial process facility. The commercial process facility simulator may run simulations based on the CVs by using the CVs directly, using outputs from the wellbore clean-up simulator that were generated based on the CVs, or a combination thereof. The commercial process facility simulator then outputs the computed function F based on both simulators in the coupled configuration (block 378).

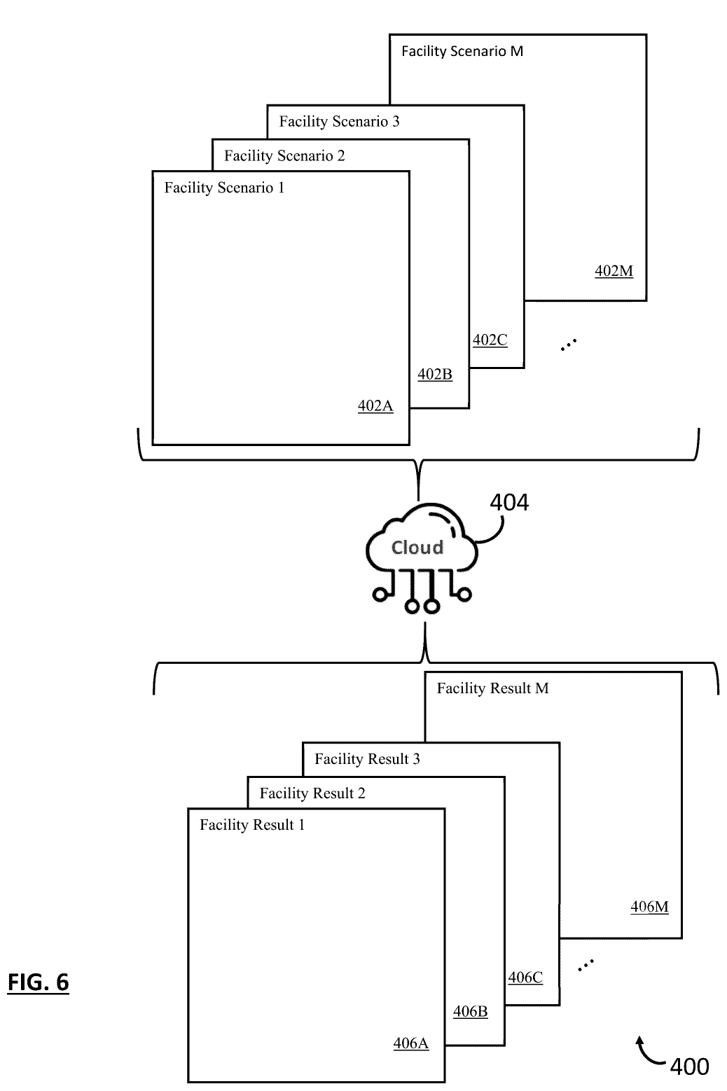

As the result of the function depends on the facility and its conditions, the output of the ‘coupled’ solution at each trial in the optimization as well behavior will likely vary depending on its associated facility design. Although some situations may be addressed using lookup tables, some functions (e.g., especially user defined functions) may not be amenable to such foreknowledge and may rely on the coupled connection simulators. However, different realizations of different surface facilities may still be useful. In other words, multiple realizations representing any number of different functioning realizations of the surface facilities may be designed and each optimized for. FIG. 6 shows a process 400 with multiple scenario 402A, 402B, 402C, and 402M referred to together as scenarios 402. Each scenario 402 corresponds to a separate, functional, and viable wellhead facility configuration. Because each optimization and its subsequent objective function are entirely separate, the sets of control variables (CVs) may be unique to the different scenarios 402. Even if the CVs pertaining to one simulator (e.g., the wellbore clean-up function) may be identical for different scenarios, there may be varied CVs for the other simulator (e.g., the commercial process facility simulator). Thus, some realizations may have unique/different CVs for one simulator while remaining consistent for the other simulator between the realizations. For each scenario 402, a common objective function, F, may be evaluated. The scenarios 402 may be stored in a library, may be user generated, and/or may be dynamically generated using real-world measurements from a facility as CVs for simulation. The real-world measurements may be derived from the exact facility to be simulated or may be derived from a similar process facility.

As illustrated, this evaluation may be performed using cloud/distributed computing 404. However, in some embodiments, a single computing device may process multiple or even all scenarios 402 to generate respective facility results 406A, 406B, 406C, and 406M. In some embodiments, the cloud/distributed computing 404 may utilize a dedicated application on a software platform, such as Delfi, made available by SLB.

Some facility realizations may only use different CVs types, such as continuous CVs, mixed integer non-linear optimizations, and the like. Each realization is, therefore, entirely case dependent, but the teachings herein are applicable to each of these different classes of problems. For instance, for surface carbon capture flaring facilities, the continuous variables may include partial oxide syngas temperature, flaring gas flow measurement entering the burner, pressure drop across the carbon dropout chamber, and the like. Partial oxidized syngas temperature variables can be used to help calibrate a control valve opening on the oxidant flow rate reaching the pre-burner. Temperatures representing a proper combustion of flaring gas with minimal oxidation to CO₂ gas would optimize the carbon capture and heat loads on the economizer and air-cooling units. Flaring gas flow measurement entering the burner may be an alternative consideration for oxidant flow control, where a set flow ratio with oxidant could be held constant. Pressure drop across the carbon dropout chamber is the difference across two measured pressures around the carbon dropout chamber (representing a pressure drop). This difference would allow for eventual complete bypass of the syngas generation through a shutoff valve for the flaring gas to the burner. This bypass may be triggered with a spike in pressure drop as this would signify the complete filling of the carbon dropout chamber that would be associated with an undersized surface facility.

As an example of discrete facility scenarios, a wellbore clean-up facility may be revised for CO₂ emissions reduction. Scenarios for carbon capture flaring facility modules would include optimal selection of preset equipment sizes for expected wellbore clean-up application throughputs. This optimization would consider potential of multiple smaller facility modules or larger single modules being used for planned application. The discrete factors for consideration in optimization may include already available and reusable facilities to send to the field and the resources' schedules based on opportunity and availability among others. This scenario includes multiple surface facilities manufactured for carbon capture opportunities and scheduled between carbon chamber storage discharges.

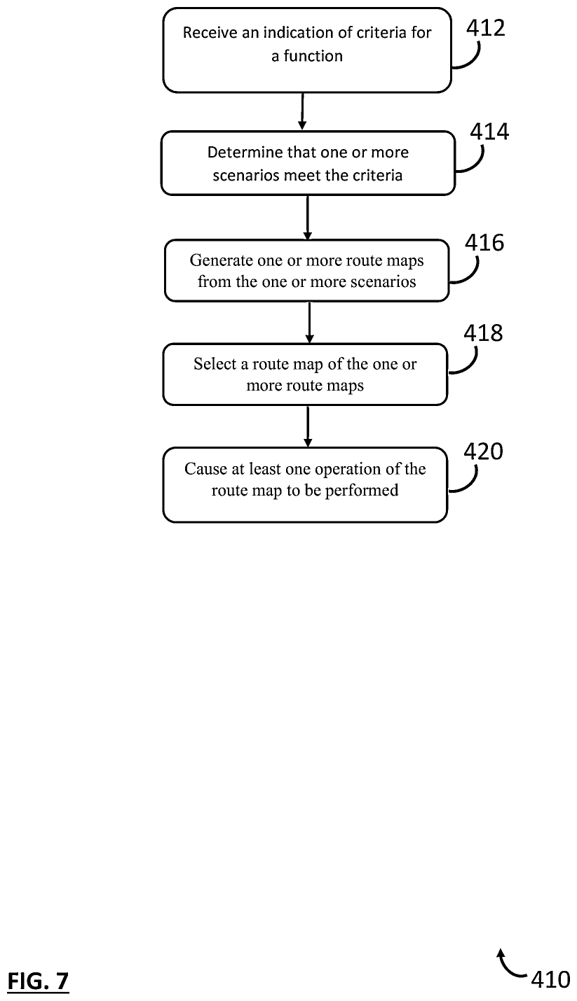

As may be appreciated, the objective function, F, may be used in controlling operation of the commercial process facility/oilfield. For example, as illustrated in process 410 of FIG. 7, the computing device 254 at the commercial process facility/oilfield or remote from the commercial process facility/oilfield may receive an indication of criteria for a function (block 412). The criteria may include various CVs, facility configurations, facility conditions, operations to perform, objective function F, other factors to optimize (e.g., CO₂ emission reduction, etc.), and/or other considerations. The computing device 254 then determines that one or more scenarios meet the criteria (block 414). For instance, the scenarios may be the scenarios 402 of FIG. 6 based on the particular facility configurations/conditions, CVs, and F for the criteria. The computing device may generate one or more route maps from the one or more scenarios (block 416). For instance, the one or more route maps may be generated based at least in part on the processes 300 and 330. Furthermore, the computing device 254 may select a route map of the one or more route maps (block 418). For instance, one or more parameters may be used to select a specific route map. For instance, the route map may include preferred steps, may include a preferred order of steps, may have a higher level of optimization, may optimize particular items more heavily, may have better key performance indicators, may match a desired curve better for a parameter (e.g., using a best fit curve), or any other suitable mechanism for distinguishing. Additionally or alternatively, the computing device 254 may select the route map in response to receiving a selection from a user. The computing device 254 may then cause at least one operation of the route map to be performed (block 420). For instance, the computing device 254 may use the route map to change a variable choke orifice size, change pump speed/pressure, open or close valves, and/or any other mechanism that may be applicable in a clean-out operation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

What is claimed is:

1. A method, comprising:
receiving an indication of criteria for a function to be performed at a commercial process facility;
determining that one or more scenarios meet the criteria;
generating one or more route maps from the one or more scenarios using coupled simulators;
selecting a route map of the one or more route maps; and
causing at least one operation of the route map to be performed.

2. The method of claim 1, wherein the commercial process facility comprises an oilfield.

3. The method of claim 1, wherein the function is an optimization of a wellbore clean-up process.

4. The method of claim 3, wherein the optimization comprises maximizing clean-up quality in a least amount of time, minimizing CO₂ emissions, minimizing an amount of area occupied by wellhead equipment and connections, or minimizing sound emission.

5. The method of claim 1, wherein determining that the one or more scenarios meet the criteria comprises comparing the criteria to the one or more scenarios that are stored in library.

6. The method of claim 1, wherein determining that the one or more scenarios meet the criteria comprises comparing the criteria to the one or more scenarios received from a user.

7. The method of claim 1, wherein determining that the one or more scenarios meet the criteria comprises comparing the criteria to the one or more scenarios that are generated using real-world measurements of the commercial process facility or a similar commercial process facility.

8. The method of claim 1, wherein the criteria comprises control variables, facility configurations, facility conditions, operations to be performed, or optimization factors.

9. The method of claim 1, wherein selecting the route map comprises receiving a selection of a route map from a user.

10. The method of claim 1, wherein selecting the route map comprises matching the selected route map to key performance indicators or matching the selected route map to preferred steps or orders of steps.

11. The method of claim 1, wherein causing the at least one operation of the route map to be performed comprises causing a change in orifice size of a variable choke.

12. A system, comprising:
one or more memory devices storing instructions; and
one or more processors configured to execute the instructions to cause the one or more processor to:
transmit control variables for a wellbore clean-up operation of a wellbore to a wellbore clean-up simulator;
run the wellbore clean-up simulator using the control variables;
run a commercial process facility simulator in a coupled configuration with the wellbore clean-up simulator based at least in part on the control variables, wherein the commercial process facility simulator simulates the wellbore clean-up operation in a commercial process facility that comprises the wellbore; and
output a function based on both simulators in the coupled configuration.

13. The system of claim 12, wherein outputting the function comprises changing at least one property of the commercial process facility.

14. The system of claim 13, wherein the at least one property comprises an orifice size of a variable choke, a pump speed or pressure, or opening or closing a valve.

15. The system of claim 12, wherein running the commercial process facility simulator comprises transmitting the control variables to the commercial process facility simulator.

16. The system of claim 12, wherein running the commercial process facility simulator comprises transmitting at least some parameters from the wellbore clean-up simulator to the commercial process facility simulator.

17. A system, comprising:
one or more memory devices storing instructions; and
one or more processors configured to execute the instructions to cause the one or more processors to:
receive an indication of criteria for a function to be performed at a commercial process facility;
transmit control variables for one or more facility scenarios to a wellbore clean-up operation of a wellbore to a wellbore clean-up simulator;
run the wellbore clean-up simulator using the control variables;
run a commercial process facility simulator in a coupled configuration with the wellbore clean-up simulator based at least in part on the control variables, wherein the commercial process facility simulator simulates the wellbore clean-up operation for the one or more facility scenarios in the commercial process facility that comprises the wellbore;
output a respective result for each of the one or more facility scenarios based on both simulators in the coupled configuration;
select a result from the respective results; and
cause at least one action to be performed at the wellbore based on the selected result.

18. The system of claim 17, wherein the at least one action comprises changing an orifice size of a variable choke, changing a pump speed or pressure, or opening or closing a valve.

19. The system of claim 17, wherein selecting the result comprises selecting the result based on key performance indicators of the respective results or based on receiving a selection of the result from a user.

20. The system of claim 17, wherein selecting the result is based on the result comprising preferred operations or orders of operations.
